(19) United States
(12) Patent Application Publication
(10) Pub. No.: US 2005/0165665 A1
(43) Pub. Date: Jul. 28, 2005

(54) Billing in a communication system

(76) Inventors: Juha-Pekka Koskinen, Hameenlinna (FI); Juha R. Vallinen, Nokia (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/508,146

(22) PCT Filed: Mar. 26, 2002
(86) PCT No.: PCT/IB02/00936

(51) Int. Cl. G06F 17/60

(52) U.S. Cl. 705/34; 705/1

(57) ABSTRACT

A communications system comprises at least one client and at least one service provider for providing a service and a charge node. The at least one service provider is arranged to provide the charging node with charging information and the charge node is arranged to determined a charge associated with the service.

### FIELD OF THE INVENTION

The present invention relates to a communication system in which a service provider is arranged to provide a service.

### BACKGROUND OF THE INVENTION

The strong growth in the number of internet users and services provided through the internet has been one of the most remarkable phenomena in communications in recent years. Another current trend is the increasing use of various mobile terminals such as laptops, PDA equipment (personal digital assistance) such as palm tops and the like) and intelligent telephones.

The wireless communication network and internet network technologies are gradually converging to make the packet switched data services used in the internet available to mobile users. Initially, the technology developed for the internet has primarily been designed for desktop computers and medium to high band width data connections. In contrast, the mobile terminal environment is generally characterised by less band width and smaller connection stability in comparison to the fixed networks. Additionally, terminals tend to have smaller displays, less memory and less powerful processors as compared to desktop computers or the like.

However, IP based packet services which are usable in a wireless mobile environment are being developed at an increasing rate. This is partly due to demand by users of mobile terminals and partly due to the development of new technologies which are attempting to increase the available band width, improve quality of service and data security. The new standards which are being developed include GPRS (general package radio service), UMTS (universal mobile telecommunication system) and WAP (wireless application protocol). These are by way of example only. The GPRS standard aims to provide high quality services for GSM subscribers by efficiently using the GSM infrastructure and protocols. In addition, the GPRS radio service is designed to provide packet based services. WAP defines a set of standard components enabling communications between mobile terminals and servers providing a service in the network. WAP utilises properties which connect the wireless domain with the world wide web (www) domain.

The introduction of services in the new network environment is complicated as different network technologies are used and that several parties or organisations are involved. One area which needs to be addressed is the implementing of billing. In particular, the question as to how to implement a billing process when an end user who is typically in the wireless domain, and thus subscribing to a network operator uses services provided by the www domain typically from a different service provider to the network operator.

In one known service architecture, the clients (users or the mobile equipment) access the services through a gateway and a separate entity is provided for managing the actual billing. This entity is referred to as the ISB (internet service broker). The ISB keeps the account of the subscribers and performs various functions associated with billing. The ISB also serves as an entity through which subscribers can subscribe to the services provided by the content servers in the network.

EP-A-924630 describes a service architecture of the type mentioned above where a separate proxy server handles access control. In order to find out the price related to a resource requested by a client, the proxy intercepts all resource requests directed to a content server. The proxy caches each request and sends a header request to the content server, requesting the content server to transmit a header associated with the requested resource back to the proxy. The header informs the proxy about the billing and/or access information associated with the requested resource, whereby the proxy authenticates the client's right to receive the requested resource whenever the header indicates that there are billing and/or access restrictions involved. Authentication is performed with an ISB handling client identification, authentication and billing.

In some proposals, a client is billed in dependence on the amount of data sent to the client. However, problems can arise if the same data has to be resent to the client. The client may therefore be charged twice for the same data.

Another problem with the currently proposed mechanisms for billing is that they are complicated and require the passing of information and requests for information between a number of different entities and the calculation of the correct billing amount.

### SUMMARY OF THE INVENTION

It is an aim of embodiments of the present invention to address one or more of the problems discussed previously.

According to a first aspect of the present invention, there is provided a communications system comprising at least one client, at least one service provider for providing a service, and a charge node, said at least one service provider being arranged to provide charging node with charging information and said charge node being arranged to determine a charge associated with said service.

According to a second aspect of the present invention, there is provided a communications system comprising at least one client, at least one service provider for providing a service, and a charge node, wherein said at least one client is charged based on the volume of data received, said charge node being provided with information such that a user is charged only once for data which is resent.

According to a third aspect of the present invention, there is provided a communications method for providing a service from a service provider to a client, said method comprising the steps of sending from the service provider to a charge node charging information, and providing said client with information from at least one service provider.

According to a further aspect of the present invention, there is provided a communications method for providing a service from a service provider to a client, said method comprising the steps of providing said client with information from at least one service provider; and charging the client on dependence on the amount of information sent, said service provider providing information such that a user is charged only once for data which is resent.

According to a further aspect of the present invention, there is provided a charging node for use with a communications system in which a client is provided with a service, said charging node being arranged to receive charging information from at least one service provider.

According to a yet further aspect of the present invention, there is provided a service provider for providing a service to a client in a communications network, said service provider being arranged to provide charging information to a charging node associated with the client.

### BRIEF DESCRIPTION OF THE DRAWINGS

For a better understanding of the present invention and as to how the same may be carried into effect, reference will now be made by way of example to the accompanying drawings in which:

FIG. 1 shows one example of a the basic architecture with which embodiments of the present invention can be used;

FIG. 2 shows diagrammatically a PDP contact between two content servers and a GGSN;

FIG. 3 shows a flow diagram illustrating a method embodying the present invention; and

FIG. 4 shows the flow of signals in one embodiment of the invention.

### DETAILED DESCRIPTION OF EMBODIMENTS OF THE PRESENT INVENTION

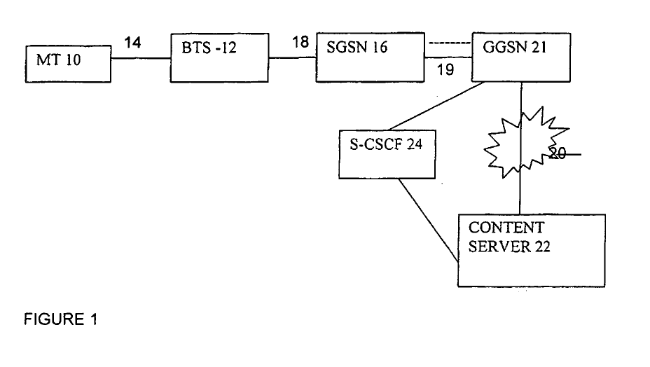

Reference is made to FIG. 1 which shows a schematic representation of a system incorporating embodiments of the present invention. Before describing the arrangement of FIG. 1, some of the terms used in this document will be explained. A service refers generally to a process in which a client contacts a content server and a session is established between the two. During this session, data may be provided to the client from the content server or vice versa. By way of example, the content server may, for example, provide a sports result service, a news service or indeed any other service. A client is the user equipment terminal which is connected to the wireless network. The client can be a mobile terminal in some embodiments of the present invention and in other embodiments of the present invention may be a fixed line or wired terminal. The terminal can include a laptop, mobile telephone, PDA (personal digital assistant) equipment, an intelligent telephone or any other suitable user equipment. Content server is the term used to describe an entity which can provide a service to the client. This service will typically consist of the provision of information but can take any suitable form.

In the arrangement shown in FIG. 1, the client 10 is a mobile terminal. The mobile terminal is arranged to communicate with a base transceiver station 12 via a wireless connection 14. The base transceiver station 12 is connected to a signalling GPRS support node (SGSN) 16 via a connection 18. The connection 18 is usually a wired connection. The SGSN 16 is connected to a gateway GPRS support node GGSN 21 via a connection 19. Connection 19 is usually a wired connection.

The GGSN 21 is a gateway node and is connected to the internet 20. The mobile terminal, base transceiver station, SGSN and GGSN are all part of a GPRS network operating in accordance with the GPRS standard. The GGSN allows a client connected to the GPRS network to communicate with the internet 20. The internet is connected to various content servers 22 only one of which is shown in FIG. 1. The content server is typically, but not always, controlled by a different operator to the network operator.

Also shown in FIG. 1 is a S-CSCF (serving call state control function) 24.

It should be appreciated that in alternative embodiments of the present invention, the content server may be connected to the network via other types of connection instead of the internet connection shown in FIG. 1. The content server is shown in FIG. 1 as being external to the network. In alternative embodiments of the present invention, the content server may be part of the network.

When a connection is established between the client 10 and the content server 22 this is referred to as a PDP (packet data protocol) context session. Generally, there will be a signalling PDP context for control signals and a secondary PDP context for content (ie data to be provided to the client) transfer. The PDP context for content transfer follows a path from the content server to the GGSN 21, via the internet 20. From the GGSN, the content is transferred to the SGSN via connection 19. The SGSN 16 passes the content to the base transceiver station 12 via connection 18. In turn, the base transceiver station passes the content to the mobile terminal 10 via the air interface 14. It should be appreciated that as the content is transferred to the various entities between the content server and the client 10, the form of the data may be changed so as to be in accordance with the protocols used by the various entities.

The signalling PDP context follows a path from the content server 22 to the S-CSCF 24, from the S-CSCF to the GGSN 21 and from the GGSN 21 to the SGSN 16. It should be appreciated that in some embodiments of the present invention, the S-CSCF entity 24 may be omitted and its function provided by a different network element. In some embodiments of the present invention, the signalling context may be passed directly from the content server 22 to one of the GPRS nodes such as the SGSN or the GGSN. It should be appreciated that in alternative embodiments of the present invention, the S-CSCF may be connected to a number of content servers. The S-CSCF is part of an IP multimedia system

In preferred embodiments of the present invention, the content server 22 is arranged to provide predefined charging information. The content server can provide any suitable charging information. In one embodiment of the present invention, the content server provides information as to the size of the content in, for example, bytes. Additionally or alternatively, the content server provides information if the access charging (that is the base charge for accessing a particular service) in GPRS in relation to the particular content should be charged at full price, be discounted and if so by how much, or free. In preferred embodiments of the present invention, the user is charged in dependence on the actual size of the information and the subscriber does not have to pay for any packets which need to be retransmitted.

If the content server changes within the PDP context session (either the signalling or the data context connection) the new content server gives new charging information.

The information which is provided by the content server or servers 22 is used by a node in the GPRS network responsible for billing. That may for example be the GGSN or may be a different node. In one embodiment of the present invention, the GGSN calculates the overall data volume for each PDP context and according to the information received from the content server charging information, the GGSN can calculate total cost of a session.

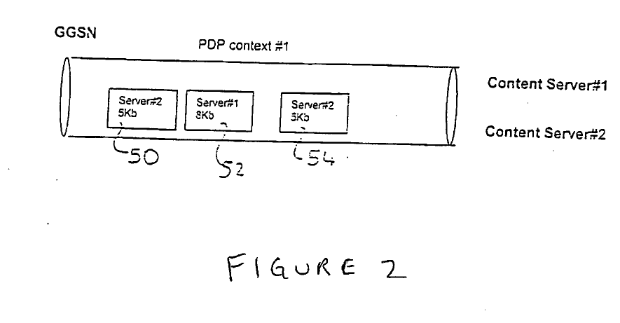

Embodiments of the present invention will now be described in more detail. Referring to FIG. 2 this shows a PDP context connection between a GGSN and two content servers, No 1 and No 2. The PDP context connection is for a single client. In other words, a client is arranged to receive information from two content servers. It should be appreciated that in embodiments of the present invention, in a given session, a client may receive information from one, two or more content servers. The information from the different content servers may be provided one after the other or may be provided in an interleaved fashion or in any other suitable way.

In the arrangement shown in FIG. 2, the second content server No 2 has sent first and third packets 50 and 54 respectively. The first content server No 1 has sent the second packet 52. In the embodiment shown in FIG. 2, the first and third packets each contain 5 kilobytes whilst the second packet contains 8 kilobytes. From the GGSN point of view, in the same PDP context there is 18 kilobytes of data to be transferred from the two different content servers. Both of the content servers provide information about the size of the “service”. Thus, server No. 1 provides the information that the information from the content server No 1 is 8 kilobytes. The content server No 2 will provide the information that the information from the second content server is 10 kilobytes. The servers may also provide information as to the type of data. For example, the content server No 1 may provide the information that the information is in the form of video information. Content server No 2 may provide the information that the information is in the form of audio information. Additionally, the content servers will provide actual charging information. For example, the content server No 1 may provide the information that there is to be no charge for access. On the other hand, content server No 2 may indicate that information from the content server No 2 is to be charged at a normal access fee, based on the transferred byte.

When the POP context is released, the call data register of the GGSN will have the total data volume that is 18 kilobytes. However, the GGSN will also have the information that 8 kilobytes is free of charge and that 10 kilobytes will be charged with the normal access fee based on the transferred bytes. From this, the GGSN is able to calculate how much a user should be charged for a given PDP session.

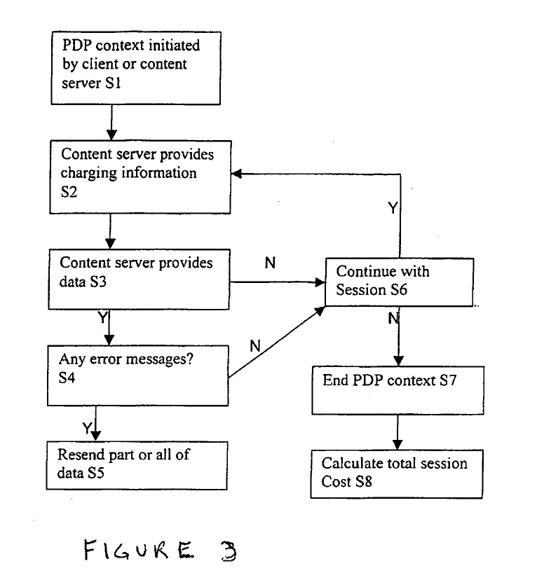

Reference is made to FIG. 3 which shows a method embodying the present invention.

A POP context is initiated by the client or the content server in step S1. The client may have subscribed to a service which automatically provides information to the client. For example, the client may be provided with the final scores of certain football matches as soon as they are available or the like. The content server provides the charging information in step S2. This will be to the GPRS node or element responsible for charging.

In step S3, the content server will provide the content or data or information to the client. It should be appreciated alternatively steps S2 and S3 may take place at the same time. Alternatively, step S3 can take place before step S2.

In step S4 a check is made to see whether there are any error messages indicating that any part of the data has not been correctly received. These error messages can be generated by the client, the base transceiver station, the SGSN, or the GGSN. In practice, there is no real check as such for the error messages. Rather, if an error message is received then it is actioned. In particular, in step S5, on the receipt of an error message, part or all of the data is resent. In embodiments of the present invention, if any part of the data needs to be resent, the content server will not be sent the charging information. In other words, the user is only charged once for a particular data packet regardless of the number of attempts which are required in order to send the data packet to the client. If there are no errors, then the next step S6 effectively determines whether or not the PDP session is to be ended or whether it is to continue. If the PDP session is to continue, then the next step will be step S2. It should be appreciated that the session can continue with the same content server providing another set of information. Alternatively, the session may continue with another content server as discussed previously.

If the session has ended, the next step is S7 in which the PDP context is ended.

In step S8, the total session cost is calculated in the GGSN or the entity handling the charging. It should be appreciated that in practice the costs of the session may be accumulated. This means that the accumulated cost is determined in step S2.

The method is then ended.

It should be appreciated that in alternative embodiments of the invention, the content server can provide the charging information at the end of a session, after the data or the service or the like has been provided to the user.

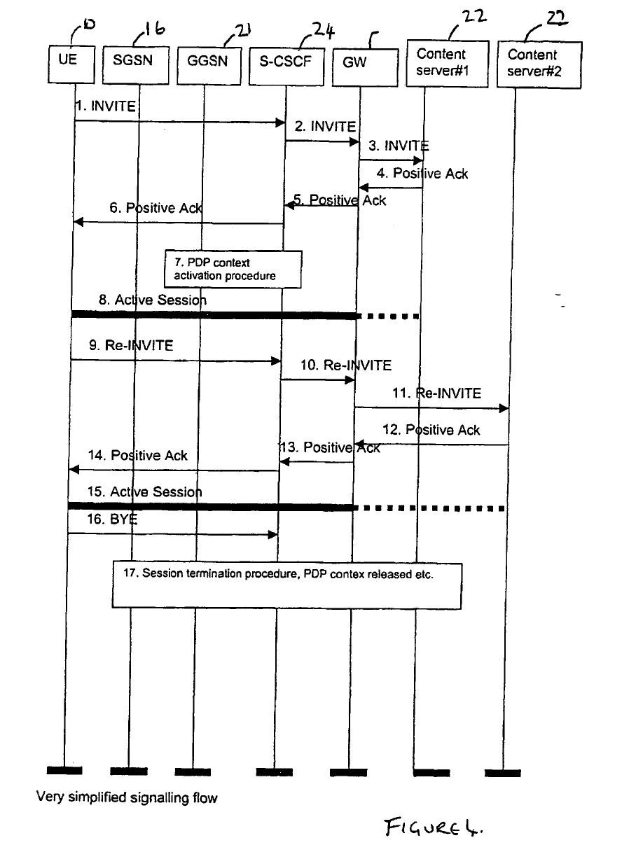

Reference is now made to FIG. 4 which shows the signal flow in the embodiment described hereinbefore. The number listed refer to the step number shown in FIG. 4.

1. An INVITE message sent from the mobile station 10 or other user equipment UE to S-CSCF 24. This is used to establish a session.

2. The INVITE message is sent from the S-CSCF 24 to the GW. This gateway may be between the GGSN and the internet. The gateway GW hides external connections to the Content Servers 22.

3. The INVITE message is sent from the gateway GW to a first one of the Content Servers 22.

4. An Acknowledgement is sent from the first content server to the gateway GW In this message the actual requested data size of the service to be provided by the content server could be included

5. The acknowledgement is sent from the GW to the S-CSCF 24. The S-CSCF stores the actual data size info

6. The Acknowledgement is sent from the S-CSCF 24 to the user equipment UE 10

7. Next a PDP context activation procedure is followed to set up a PDP context or connection. Also in this phase the actual data size and possibly charging information from the first content server could be sent to the GGSN 21. The GGSN 21 may store that information.

8. Next an active session is in place where the data or service is provided by the content server. DATA is transferred from the first content server to the mobile station 10.

9. A Re-INVITE message is sent from the mobile station 10 to the S-CSCF 24. Thus, if a new service is required, there is no need to update the PDP context

10. The Re-INVITE message is sent from the S-CSCF 24 to the gateway GW

11. The Re-INVITE message is sent from the gateway GW to a second content server 22.

12. An Acknowledgement is sent from the second content server to the gateway. In this message the actual requested data size could be included.

13. The Acknowledgement is sent from the gateway GW to the S-CSCF 24. The S-CSCF stores the actual data size information. It is alternatively or additionally possible to transfer the actual data size and possibly charging information from the second content server to the GGSN 21. GGSN 21 may store that information.

14. The Acknowledgement is sent from S-CSCF 24 to the mobile terminal UE

15. An Active session commences. DATA is transferred from the second content server to the user equipment 10. It should be appreciated that the session may change between the first and second content servers several times.

16. Next a BYE or termination message is sent from the user equipment 10 to the S-CSCF 24 when a session is completed

17. Session termination procedure is then performed, releasing the PDP context.

When the Content Servers acknowledge the release, they can in alternatively or additionally include in the Acknowledgement message the size of actual data. Also in this phase S-CSCF could send actual data sizes for the first and second content servers to the GGSN.

Embodiments of the present invention have the advantage in that since the content server provides information relating to the volume of data, there is no need to try and identify individual data packets going through a node. There is also no need to determine whether or not the packet is a resent packet or not.

The content server charging information can take any suitable form. As mentioned previously, the information can include the size of the content, or any other suitable unit. The content server charging information can also provide information on the charging parameters such as whether or not the access is to be free, at a discounted price or at a full price. As an alternative or in addition, the content server may simply provide information relating to the cost of the particular session or at least for the data from the particular content server. Where there are two or more content servers, the cost from the various content servers may need to be accumulated.

By using the content server charging information to provide to the transaction controlling function point, such as the S-CSCF or SGSN/GGSN, all that is needed is the charging information. In this way, it is possible to have different content servers on the same PDP context. There is also no need to try to determine the type of the transmitted bytes, that is whether or not it is a video or audio clip or the like.

Embodiments of the present invention allow the function provided in the charging node to be considerably simplified The access level transfer capability is chargeable as such. Whilst a user will not be charged twice for any packets which need to be resent, the user may still have to pay for the access even in no packets are received.

However, this will depend on the charging information provided by the content server. Some services may have a fixed price, be dependent on the amount of data, be dependent on the access time or use any other suitable criteria for charging.

The charging node can be inside the network or outside the network. In some embodiments of the present invention, the charging node function may be provided by an internet service broker ISB. The ISB is usually within the network associated with the user, that is the within the network which controls billing to the user. For example, the ISB may be connected to the gateway. However in some alternative embodiments, the ISB may be outside the network and may for example be in a network associated with a third party. The ISB will usually have access to the accounts and profiles of the users. The ISB will receive the charging information from content server. The ISB uses this information to determine how the user should be charged for the service provided by the content server. The ISB may for example receive the information it requires from content server via the gateway.

By having the content server provide the charging information, it in practice makes it easier for the network operator to use content service charging information for revenue sharing.

Embodiments of the present invention have been described particularly in the context of a GPRS system. It should be appreciated that embodiments of the present invention can be used in any other suitable network. Embodiments of the present invention have been described particularly in the context of a wireless network. It should be appreciated that embodiments of the present invention can also be used in wired networks.

Embodiments of the present invention have been described above with reference to the embodiments shown in the drawings. It is obvious that embodiments of the present invention are not limited to these particularly embodiments but may be modified by those skilled in the art without departing from the scope of the invention.

1. A communications system comprising:
at least one client;
at least one service provider for providing a service; and
a charge node, said at least one service provider being arranged to provide said charge node with charging information associated with said service and said charge node being arranged to determine a charge associated with said service in dependence on said charging information.

2. A communications system as claimed in claimed in claim 1, wherein said service provider is arranged to define the cost of the service.

3. A communication system as claimed in claim 2, wherein said cost is defined by defining the actual cost of the service.

4. A communications system as claimed in claim 2, wherein said cost is defined by defining the basis on which the cost of the service is determined.

5. A communication system as claimed in claim 4, wherein the cost is defined by defining the cost of for a unit of data.

6. A communications system as claimed in claim 1, wherein the charge node is arranged to determine the charge only once for any data which has to be resent.

7. A communications system as claimed in claim 1, wherein the client and optionally the charge node are in a cellular telecommunications network.

8. A system as claimed in claim 7, wherein said cellular telecommunications network operates in accordance with the GPRS standard.

9. A system as claimed in claim 8, wherein said charge node is one of:
GGSN: SGSN; and ISB.

10. A system as claimed in claim 1, wherein said at least one client is connectable with said service provider via an Internet connection.

11. A system as claimed in claim 1, wherein said service provider is a content server.

12. A system as claimed in claim 1, wherein said service provider and said client are connected in a PDP context session.

13. A system as claimed in claim 1, wherein said client is connectable to a plurality of service providers in a single connection.

14. A system as claimed in claim 1, wherein said client comprises:
a mobile station; a mobile terminal; a portable computer; a PDA; a telephone; a fixed terminal; a fixed station; a computer; or a PC.

15. A system as claimed in claim 1, wherein the charge node is arranged to determine the cost of a connection at the end of the connection.

16. A communications system comprising:
at least one client;
at least one service provider for providing a service: and
a charge node, wherein said at least one service provider is arranged to provide said at least one client with data, said charge node arranged to charge said at least one client in dependence on the volume of data received, said charge node being provided with information from the at least one service provider such that a user is charged only once for data which is resent.

17. A communications method for providing a service from at least one service provider to a client, said method comprising the steps of:
sending from the at least one service provider to a charge node charging information associated with said service; and
providing said client with information from at least one service provider.

18. A method as claimed in claim 17, comprising the step of determining at the charge node the cost of said service.

19. A method as claimed in claim 17, wherein said charging information comprises one of:
a cost of said service;
a basis on which a cost of said service is determined; and
a cost for a unit of information.

20. A communications method for providing a service from a service provider to a client, said method comprising the steps of:
providing said client with data from at least one service provider; and charging the client in dependence on the volume of data received, said service provider providing information to the charge node such that a user is charged only once for data which is resent.

21. A charge node for use with a communications system in which a client is provided with a service, said charging node being arranged to receive charging information from at least one service provider and determine a charge associated with said service in dependence on said charging information.

22. A service provider for providing a service to a client in a communications system, said service provider being arranged to provide charging information to a charging node associated with the client.
